(19) United States
(12) Patent Application Publication
(10) Pub. No.: US 2017/0004191 A1
(43) Pub. Date: Jan. 5, 2017

(54) INFORMATION PROCESSING APPARATUS AND INFORMATION PROCESSING METHOD

(71) Applicant: MITSUBISHI ELECTRIC CORPORATION, Tokyo (JP)

(72) Inventor: Takayoshi IIDA, Tokyo (JP)

(21) Appl. No.: 15/125,623

(22) PCT Filed: Jun. 17, 2014
(86) PCT No.: PCT/JP2014/066060

§ 371 Date: Sep. 13, 2016

(51) Int. Cl. G06F 17/30

(52) U.S. Cl. CPC G06F 17/30572; G06F 17/3053; G06F 17/30554

(57) ABSTRACT

An information processing apparatus is configured to visualize data extracted from a database and dialogically analyze the data. The information processing apparatus includes an analysis process setup file in which one or a plurality of data items necessary for data analysis are specified, a memory in which the data extracted from the database is developed in advance of visualization, and a memory development instruction unit configured to extract, from the database, data of a data item of a high rank in frequency of being used for analysis, out of the one or the plurality of data items, and preliminarily develop the extracted data on the memory in advance of the analysis.

### TECHNICAL FIELD

The present invention relate o an information processing apparatus and an information processing method.

### BACKGROUND ART

In recent years, environment for easily collecting data over a long period of time and analyzing the data has been prepared, for example, the inexpensive and high-speed computing environment and the inexpensive sensor network environment. Consequently, analysis aiming at improvement in efficiency of job operation, abnormality detection of installed apparatuses, and overall optimization of the installed apparatuses has come to be widely performed,

The data analysis for acquiring necessary information from a large amount of data is known as data mining method. Regarding the data analysis effectively utilizing the data mining method, a method of visualizing the data to be analyzed with a computer and dialogically analyzing the data with participation of human has been proposed (see, for example, Patent Literature 1).

When the efficiency of job operation is analyzed, improvements of the daily job operation is often visualized through the same periodical analysis process, and consequently the analysis process once utilized may be preserved, for example, as a setup file, to be reused. In addition, in the analysis related to abnormality detection of the installed apparatuses and to overall optimization of the installed apparatuses, the same analysis process is frequently used, and consequently the frequently used analysis process may be prepared in advance as a setup file.

### CITATION LIST

### Patent Literature

Patent Literature 1: Japanese Unexamined Patent Application Publication No. 2008-204282 (pages 4 and 5)

### SUMMARY OF INVENTION

### Technical Problem

With the conventional analysis method, however, the longer time is required to process to extract data from a database, as the data volume becomes larger. Thus, through the dialogical data analysis, including visualizing the extracted data and performing trials and errors based on the operator's recognition of the visualized data, responsiveness is impaired and hence interactiveness is impaired. Although the mentioned drawbacks may be overcome by improving the processing capacity of the computer, a plurality of computers or an expensive computer has to be prepared to improve the processing capacity. Consequently, with an inexpensive computer with an ordinary processing capacity cannot dialogically analyze the large-scale data.

The present invention has been accomplished to solve the foregoing problem, and provides an information processing apparatus and an information analysis method that enable data analysis to be performed without compromising interactiveness.

### Solution to Problem

In one embodiment, the present invention provides an information processing apparatus configured to visualize data extracted from a database and dialogically analyze the data. The information processing apparatus includes an analysis process setup file in which one or a plurality of data items necessary for data analysis are specified, a memory in which the data extracted from the database is developed in advance of visualization, and a memory development instruction unit configured to extract, from the database, data of a data item of a high rank in frequency of being used for analysis, out of the one or the plurality of data items, and preliminarily develop the extracted data on the memory in advance of the analysis.

In another embodiment, the present invention provides an information processing method of visualizing data extracted from a database and dialogically analyzing the data. The information processing method includes extracting, from the database, data of a data item of a high rank in frequency of being used for analysis, out of one or a plurality of data items necessary for data analysis specified in an analysis process setup file, and preliminarily developing the extracted data on a memory in advance of the analysis.

### Advantageous Effects of Invention

In an embodiment of the present invention, the data of the data item of a high rank in frequency of being used for analysis is developed on the memory in advance of the analysis. Consequently, the time required for data extraction can be shortened, and the analysis can be performed without compromising the interactiveness,

### BRIEF DESCRIPTION OF DRAWINGS

FIG. 1 is a block diagram illustrating a configuration of an information processing apparatus according to Embodiment 1 of the present invention.

FIG. 2 is a schematic drawing illustrating a structure of the memory shown in FIG. 1.

FIG. 3 is a schematic drawing illustrating examples of the analysis process setup file shown in FIG. 1.

FIG. 4 is a flowchart illustrating a visualization process of data to be analyzed performed by the information processing apparatus according to Embodiment 1 of the present invention.

FIG. 5 is a block diagram illustrating a configuration of an information processing apparatus according to Embodiment 2 of the present invention.

FIG. 6 is a schematic drawing illustrating an example of an analysis process use frequency ranking file in the information processing apparatus according to Embodiment 2 of the present invention.

FIG. 7 is a flowchart illustrating a visualization process of data to be analyzed performed by the information processing apparatus according to Embodiment 2 of the present invention.

### DESCRIPTION OF EMBODIMENTS

### Embodiment 1

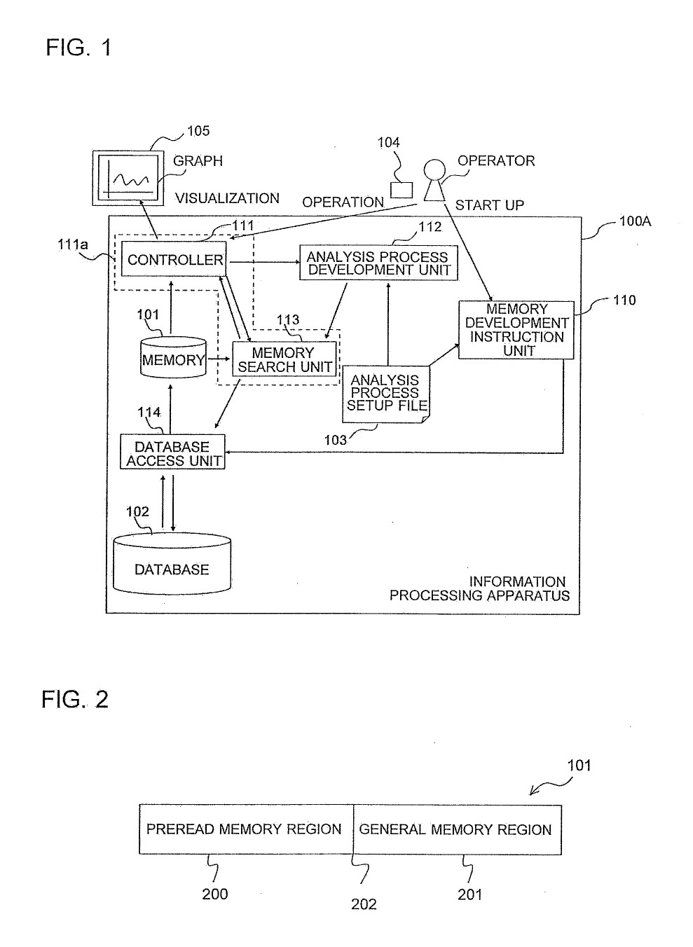

FIG. 1 is a block diagram illustrating a configuration of an information processing apparatus according to Embodiment 1 of the present invention.

An information processing apparatus 100A includes, as functional units for visualizing data, a memory development instruction unit 110, a controller 111, an analysis process development unit 112, a memory search unit 113, and a database access unit 114. In addition, an input device 104 for receiving an operation of an operator, and a display device 105 such as a display panel are connected to the information processing apparatus 100A.

First, the functional units will be described.

When the information processing apparatus 100A is started up, the memory development instruction unit 110 accesses a database 102 through the database access unit 114 based on an analysis process setup file 103 to be subsequently described, and preliminarily develops data of a data item specified in the analysis process setup file 103, on a memory 101.

The controller 111 performs processes related to inputting and outputting operations, for example, receiving an input from the operator through the input device 104 and causing the display device 105 to display the data. The analysis process development unit 112 reads the analysis process setup file 103. The memory search unit 113 detects whether the data has been developed on the memory 101.

The information processing apparatus 100A includes a control unit having a CPU, RAM, and a ROM, and the ROM contains a control program. The CPU and the control program constitute, in terms of functions, the memory development instruction unit 110, the controller 111, the analysis process development unit 112, the memory search unit 113, and the database access unit 114. Here, the controller 111 and the memory search unit 113 correspond to the visualization control unit 111a in the present invention.

The information processing apparatus 100A also includes the memory 101 that serves as a primary buffer for visualizing the data, and the database 102 for storing the data for a long period of time. Here, the memory 101 is configured to accept an access of a higher rate than the database 102, in other words, the data stored in the memory 101 can be extracted in a shorter time than the data in the database 102.

FIG. 2 is a schematic drawing illustrating a structure of the memory shown in FIG. 1.

The memory 101 includes a preread memory region 200 and a general memory region 201. The preread memory region 200 is a region for preliminarily developing the data preread based on the analysis process setup file 103 to be subsequently described, when the information processing apparatus 100A is started up. The general memory region 201 is a region for developing ordinary analysis results. The memory 101 stores a threshold 202 for delimiting a maximum capacity of the preread memory region 200.

The threshold 202 is determined as a guide of a memory capacity that allows the memory 101 to stably operate even when the preread memory region 200 is secured for preliminary development apart from the general memory region 201, in the overall region of the memory 101. This is because when the general memory region 201 is insufficient, the ordinary analysis is unable to be stably performed, and consequently the threshold 202 is determined to allocate a memory capacity that does not provoke the unstable operation, to the preread memory region 200.

The database 102 stores a plurality of pieces of data to be analyzed. Here, sensor data from temperature sensors is assumed to be stored in the database 102. Hereinafter, the data stored in the database 102 will be referred to as sensor data, the sensor data designated as object of visualization out of the sensor data stored in the database 102 will be referred to as data to be analyzed, and an item to which the sensor data belongs will be referred to as data item. The data items will herein be exemplified by identifiers of the respective temperature sensors, such as a temperature sensor A and a temperature sensor B. Although the temperature sensor data is used as example to facilitate the description, the data to be accumulated in the database 102 is not limited to the sensor data but may include different data such as operation modes of the installed apparatuses and operation history of the installed apparatuses.

The information processing apparatus 100A further includes an analysis process setup file 103 for the analysis efficiency.

The significance of the analysis process setup file 103 will be described hereunder. For example, when a malfunction occurs in the installed apparatuses, to diagnose the cause of the malfunction among numerous possible causes, it is necessary to visualize the sensor data of various sensors such as temperature sensors and pressure sensors and analyze the data by sorting out the data in time series (or superposing in the same graph region), to thereby recognize the operational tendency of the apparatuses. However, many data items are to be analyzed and a long time is required to merely select really necessary data items from the database. In addition, such management can only be performed by experienced professionals.

The analysis process setup file serves to alleviate the mentioned burden. A plurality of setup files are prepared for the respective categories of the analysis, and the process to be performed for the analysis (inclusive of data item) is specified in each of the setup files. On the basis of the foregoing description, a specific configuration of the analysis process setup file will be described hereunder.

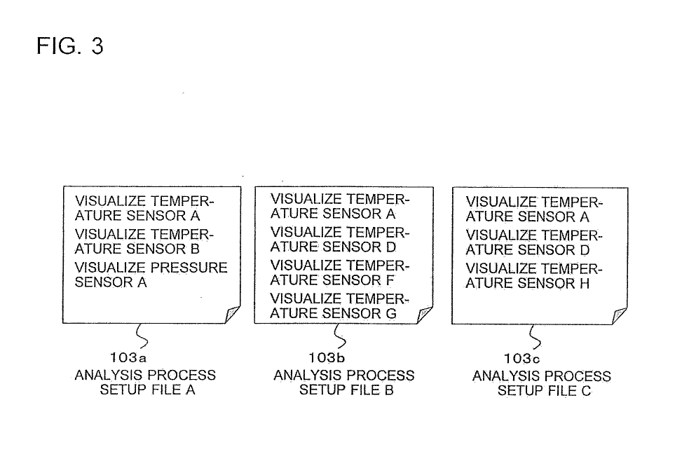

FIG. 3 is a schematic drawing illustrating examples of the analysis process setup file shown in FIG. 1.

The analysis process setup file 103 specifies, as described above, the process of determining from which data item the sensor data is to be visualized among the numerous data items of the sensor data contained in the database 102. The process specified in the analysis process setup file 103 is composed of (1) a data set including the data items necessary for data analysis, and (2) advisory information for analyzing the data. The advisory information includes, for example, from which perspective graphic data is to be analyzed. In the present invention, the configuration of the analysis process setup file 103 is not specifically limited, and the analysis process setup file 103 is only required to contain at least information indicating from which data item the sensor data is to be visualized.

When the analysis process setup file 103 is applied, for example, to the issue of “malfunction of installed apparatuses,” (1) temperature sensors and pressure sensors are designated as data items, as set of data to be visualized for the analysis. One or a plurality of data items may be designated. Regarding (2) advisory information, tips for detecting abnormality from the sensor data of the temperature sensor and the pressure sensor are specified.

In the example shown in FIG. 3, the analysis process setup file 103 includes a plurality of variations each containing a different combination of the data items depending on the category of the analysis, namely an analysis process setup file A 103a, an analysis process setup file B 103b, and an analysis process setup file C 103c. These analysis process setup files 103 include the data items common to all or some of the analysis process setup files 103, such as a temperature sensor A and a temperature sensor a Although three examples are herein used as variations of the analysis process setup files 103, the number of variations is not specifically limited. In FIG. 3, the advisory information is not illustrated.

Hereunder, distinctive features of Embodiment 1 will be described. As an outline in Embodiment 1, the sensor data of the data item high in use frequency ranking in the data analysis performed by the information processing apparatus 100A is extracted from the database 102 in advance of the analysis, and developed on the memory 101 that can be accessed at a higher speed than the database 102. Such a configuration shortens the time required for the data extraction thus to improve responsiveness in visualization of the sensor data, thereby enabling high-speed analysis by shortening the time required for the analysis as a whole. An operation according to Embodiment 1 will be described with reference to a flowchart.

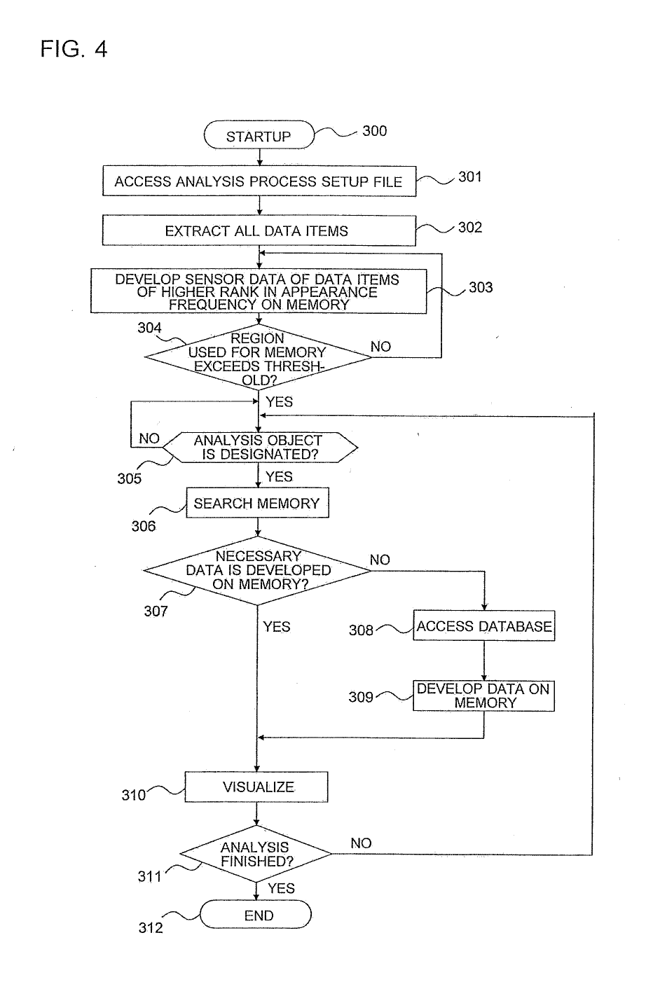

FIG. 4 is a flowchart illustrating a visualization process of data to be analyzed performed by the information processing apparatus according to Embodiment 1 of the present invention.

The process is broadly divided into a preliminary stage before the operator starts the analysis and an analysis stage after the operator starts the analysis.

### (Preliminary Stage)

First, the operator activates the information processing apparatus 100A through the input device 104 (step 300). When the information processing apparatus 100A is activated, first the startup information is transmitted from the input device 104 to the memory development instruction unit 110. When the memory development instruction unit 110 recognizes based on the startup information that the information processing apparatus 100A has been activated, the memory development instruction unit 110 accesses the analysis process setup file 103 (step 301).

The memory development instruction unit 110 accesses all of the analysis process setup files A 103a, B 103b, and C 103c, and develops all the data items contained in the analysis process setup file A 103a, B 103b, C 103c in the memory development instruction unit 110 (step 302). Specifically, three temperature sensors A, two temperature sensors D, and one each of the remaining sensors are developed in the memory development instruction unit 110.

The memory development instruction unit 110 sorts out the data items developed in the memory development instruction unit 110 in the order of use frequency. The use frequency herein refers to appearance frequency at which the data items appear in common in the plurality of analysis process setup files 103, and the data items are sorted in the order of temperature sensor A, temperature sensor D, temperature sensor B, temperature sensor F, temperature sensor G, and temperature sensor H based on the appearance frequency. The appearance frequency may be defined as the number of times of appearance, or an appearance rate representing the ratio of the number of times of appearance of a given data item to that of all the data items developed in the memory development instruction unit 110.

Then the memory development instruction unit 110 accesses the database 102 through the database access unit 114, and extracts the sensor data of the data item high in appearance frequency ranking from the database 102, and develops the extracted data in the preread memory region 200 in the memory 101 (step 303).

To be more detailed, the sensor data is developed on the preread memory region 200 in the order of the appearance frequency of the data items so that the threshold 202 is not exceeded. First, the sensor data of the temperature sensor A, highest in appearance frequency, is developed on the preread memory region 200. In the case where the memory usage does not exceed the threshold 202 with the sensor data of the temperature sensor A developed, the memory development instruction unit 110 also develops the sensor data of the temperature sensor B in the preread memory region 200 (step 304). This step is repeated unless the threshold 202 is exceeded.

### (Analysis Stage)

When the foregoing preliminary stage is completed, the analysis stage is entered. In the analysis stage, first the operator designates the object of analysis. The analysis object designation refers to the action of the operator to designate an object that the operator wishes to analyze (visualize). The steps from the analysis object designation to the visualization of the designated data to be analyzed are interactively performed as will be described hereunder.

The object to be designated in the analysis object designation may be the analysis process setup file 103 or the data items. For example, at an initial stage of the diagnosis (analysis) of the “malfunction of installed apparatuses,” the analysis process setup file 103 is designated as object of analysis, and when the analysis advances, data items not listed in the analysis process setup file are newly designated individually, for further analysis. The analysis stage will be described hereunder on the assumption that the temperature sensor A is designated in the analysis object designation.

The display device 105 displays a screen that urges the designation of the object of analysis, and the operator checks the screen display and designates the object of analysis through the input device 104. The process instructed by the operator is performed by the controller 111.

When the object of analysis is designated (step 305), the operation is shifted from the controller 111 to the memory search unit 113. The memory search unit 113 detects whether the data to be analyzed necessary for visualization, namely the sensor data of the temperature sensor A is developed on the preread memory region 200 in the memory 101 (steps 306 and 307). As stated above, the sensor data of the temperature sensor A is already developed on the preread memory region 200 in the memory 101 at the step 303. Thus, the controller 111 accesses the preread memory region 200 instead of to the database 102, to thereby extract the sensor data of the temperature sensor A at a high speed, and visualizes the data, for example, by displaying the data as a graph on the display device 105 (step 310).

When the data to be analyzed necessary for visualization is unavailable in the preread memory region 200 in the memory 101, the memory search unit 113 instructs the database access unit 114 to develop the necessary data to be analyzed on the memory 101 from the database 102 (steps 308 and 309). In this case, the data is developed on the general memory region 201. Then the controller 111 extracts the data to be analyzed developed as above from the general memory region 201, and visualizes the data (step 310). In case that the general memory region 201 is used up at the step 309, the threshold 202 of the preread memory region 200 may be revised to increase the general memory region 201.

The analysis object designation performed by the operator and the visualization of the designated data to be analyzed are repeated as described above, so that the analysis is dialogically performed with the participation of the operator.

When the operator inputs an instruction to finish the operation through the input device 104, the information processing apparatus 100A decides that the analysis has been completed, and finishes the analysis (steps 311 and 312).

Although the data items are designated in the analysis object designation at the step 305 in the foregoing description, the analysis process setup file 103 may be designated instead as stated earlier. When the analysis process setup file A 103a is designated, for example, the controller 111 issues a file access instruction to the analysis process development unit 112, to access the analysis process setup file A 103a.

Among the data items listed in the analysis process setup file A 103a, the temperature sensor A is developed on the preread memory region 200, and consequently the sensor data of the temperature sensor A is extracted from the preread memory region 200, and visualized at a high speed. In contrast, the data of the temperature sensor B, another data item listed in the analysis process setup file A 103a, is not developed on the preread memory region 200. Consequently, the data of the temperature sensor B is extracted from the database 102 and developed on the general memory region 201, and is hence visualized at a lower speed than the data of the temperature sensor A.

As described thus far, according to Embodiment 1 the data to be analyzed of the data item of a high rank in use frequency for the analysis is developed in advance on the memory 101. Consequently, the analysis can be performed at a high speed without compromising the interactiveness with the operator.

Without employing the configuration of Embodiment 1, the sensor data necessary for the analysis has to be extracted from the database 102, and hence a longer time is required for the extraction, and a longer time is required before the visualization. In contrast, according to Embodiment 1, the data to be analyzed of the data item high in use frequency ranking is developed on the memory 101 in advance of the start of the analysis. Thus, when the object of analysis designated by the operator in the analysis object designation corresponds to the data item high in use frequency ranking, the sensor data is already developed on the memory 101 before the start of the analysis, and consequently the time required for data extraction can be shortened, to improve responsiveness. Thus, the processing time required for the analysis can be shortened as a whole. In addition, because the preliminary data is developed on the memory at the time of activation of the information processing apparatus 100A, a first session of the analysis after the activation can also be performed at a high speed.

Here, although the use frequency is defined as appearance frequency at which the data items appear in common in the plurality of analysis process setup files 103 in Embodiment 1, the designation frequency at which the data item is designated in the analysis object designation of the step 304 may be employed. More specifically, in the example of the analysis process setup files 103 of FIG. 3, when the temperature sensor F is more frequently designated than the temperature sensor A and the temperature sensor B in the analysis object designation of the step 304, although the temperature sensor F is lower in appearance frequency than the temperature sensor

A and the temperature sensor B, the sensor data of the temperature sensor F may be preliminarily developed.

### Embodiment 2

In Embodiment 1, the sensor data of the data item high in use frequency ranking is preliminarily developed on the memory 101. In Embodiment 2, the sensor data of the data item listed in the analysis process setup file 103 high in use frequency ranking is preliminarily developed on the memory 101.

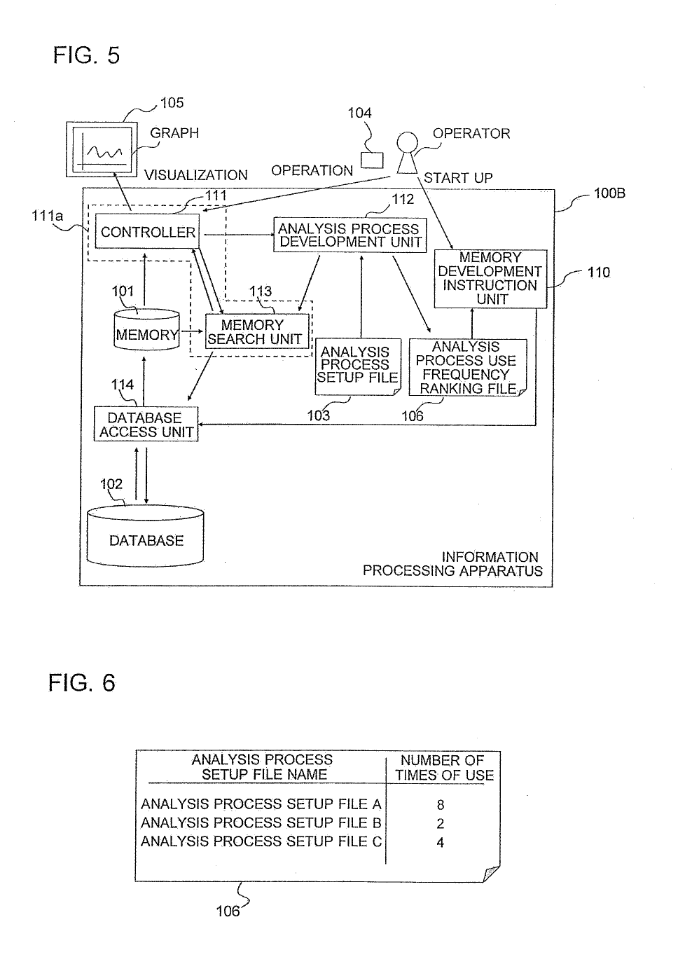

FIG. 5 is a block diagram illustrating a configuration of an information processing apparatus according to Embodiment 2 of the present invention.

An information processing apparatus 100B according to Embodiment 2 further includes an analysis process use frequency ranking file 106, in addition to the configuration of Embodiment 1 shown in FIG. 1. The configuration of the remaining portion is the same as that of Embodiment 1 shown in FIG. 1.

FIG. 6 is a schematic drawing illustrating an example of an analysis process use frequency ranking file in the information processing apparatus according to Embodiment 2 of the present invention.

In the analysis process use frequency ranking file 106, names of the analysis process setup files and the number of times of use of the file are registered in association with each other. Although the use frequency is defined as the number of times of use in Embodiment 2, a use rate representing the ratio of the number of times of use of the analysis process setup file 103 to the total number of times of use may be employed.

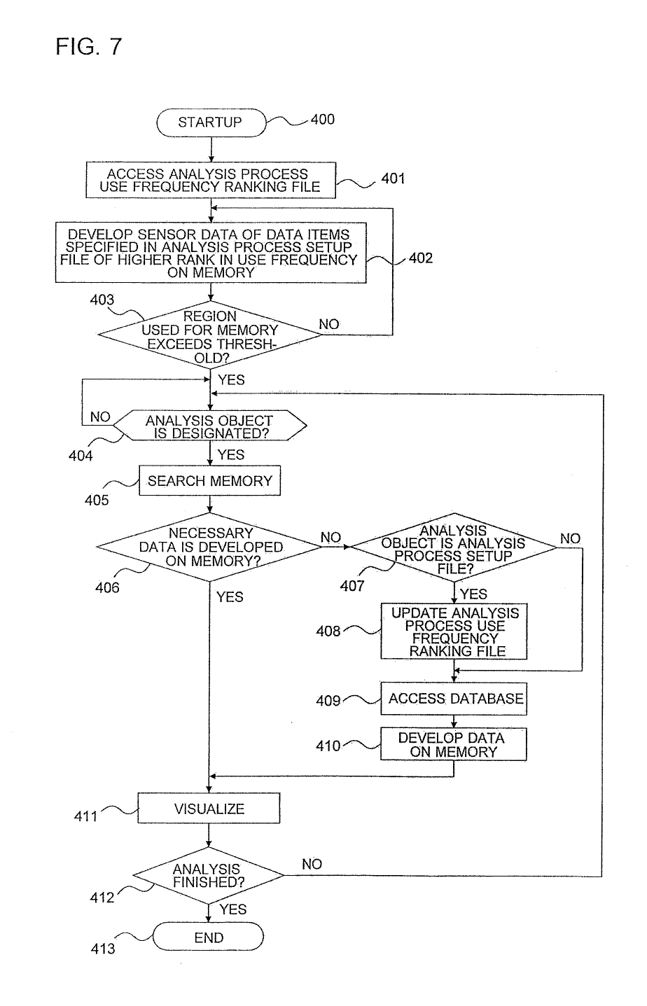

Hereunder, the operation will be described. FIG. 7 is a flowchart illustrating a visualization process of the data to be analyzed performed by the information processing apparatus according to Embodiment 2 of the present invention. The process is broadly divided into a preliminary stage before the operator starts the analysis and an analysis stage after the operator starts the analysis.

### (Preliminary Stage)

First, the operator activates the information processing apparatus 1003 through the input device 104 (step 400). When the information processing apparatus 1003 is activated, first the startup information is transmitted to the memory development instruction unit 110. When the memory development instruction unit 110 recognizes based on the startup information that the information processing apparatus 100B has been activated, the memory development instruction unit 110 accesses the analysis process use frequency ranking file 106 (step 401).

The memory development instruction unit 110 analyzes the number of times of use of the analysis process setup files 103 registered in the analysis process use frequency ranking file 106, and identifies the analysis process setup file 103 high in use frequency ranking. The memory development instruction unit 110 accesses the database 102 through the database access unit 114 for the data items listed in the analysis process setup file 103 high in use frequency ranking, and develops the corresponding data on the preread memory region 200 in the memory 101.

More specifically, in the analysis process use frequency ranking file 106 shown in FIG. 6, the analysis process setup file A has the largest number of times of use, and is hence highest in use frequency ranking. Consequently, the sensor data of the temperature sensor A and the temperature sensor B, which are the data items listed in the analysis process setup file A, is sequentially developed on the memory 101 (step 402).

To develop the data on the memory 101, the sensor data of the data items listed in the analysis process setup file 103 high in use frequency ranking is sequentially developed so that the threshold 202 in the memory 101 is not exceeded. In the case where the memory usage does not exceed the threshold 202 after the sensor data of the temperature sensor A and the temperature sensor B in the analysis process setup file A is all developed, the sensor data of the data item listed in the analysis process setup file C, second highest in use frequency ranking, is also developed on the memory 101 (step 403).

### (Analysis Stage)

When the foregoing preliminary stage is completed, the analysis stage is entered. In the analysis stage, first the operator designates the object of analysis. The analysis object designation refers to the action of the operator to designate an object that the operator wishes to analyze (visualize). The steps from the analysis object designation to the visualization of the designated data to be analyzed are interactively performed.

The object to be designated in the analysis object designation may be the analysis process setup file 103 or the data items. The analysis stage will be described hereunder on the assumption that the temperature sensor A is designated in the analysis object designation.

The display device 105 displays a screen that urges the designation of the object of analysis, and the operator checks the screen display and designates the object of analysis through the input device 104. The process instructed by the operator is performed by the controller 111.

When the object of analysis is designated (step 404), the operation is shifted from the controller 111 to the memory search unit 113. The memory search unit 113 detects whether the data to be analyzed necessary for visualization, namely the sensor data of the temperature sensor A, is developed on the preread memory region 200 in the memory 101 (steps 405 and 406). As stated above, the sensor data of the temperature sensor A is already developed on the preread memory region 200 in the memory 101 at the step 402. Thus, the controller 111 accesses the preread memory region 200 instead of to the database 102, to thereby extract the sensor data of the temperature sensor A at a high speed, and visualizes the data, for example, by displaying the data as a graph on the display device 105 (step 410).

When the data to be analyzed necessary for visualization is unavailable in the preread memory region 200 in the memory 101, the controller 111 checks whether the object of analysis designated in the analysis object designation of the step 404 is the analysis process setup file 103 (step 407). In the case where the object of analysis designated in the analysis object designation of the step 404 is the analysis process setup file 103, the controller 111 accesses the analysis process use frequency ranking file 106 through the analysis process development unit 112, and updates the number of times of use (step 408). In the case where the object of analysis designated in the analysis object designation of the step 404 is not the analysis process setup file 103, the controller 111 skips the step 408 and proceeds to the step 409.

At the step 409, the memory search unit 113 instructs the database access unit 114 to develop the corresponding data to be analyzed on the memory 101 from the database 102 (steps 409 and 410). In this case, the data is developed on the general memory region 201. Then the controller 111 extracts the data to be analyzed developed as above from the general memory region 201, and visualizes the data (step 411). In case that the general memory region 201 is used up, the threshold 202 of the preread memory region 200 may be revised to increase the general memory region 201.

The analysis object designation performed by the operator and the visualization of the designated data to be analyzed are repeated as described above, so that the analysis is dialogically performed with the participation of the operator.

When the operator inputs an instruction to finish the operation through the input device 104, the information processing apparatus 100B decides that the analysis has been completed, and finishes the analysis (steps 412 and 413).

As described above, in Embodiment 2 the use frequency of the analysis process setup file 103 is employed as index for selecting the data to be preliminarily developed on the memory 101, and consequently, similarly to Embodiment 1, the data to be analyzed most frequently analyzed by the operator can be developed on the memory 101. Consequently, the analysis can be performed at a high speed without compromising the interactiveness with the operator.

Although according to Embodiments 1 and 2 the analysis stage is entered after the preliminary stage is completed, the analysis object may be designated to proceed to the analysis stage in the middle of the preliminary stage. In this case, the operation of the preliminary stage is performed in the background of the analysis stage. For example, when the sensor data of the temperature sensor A and the temperature sensor B has to be preliminarily developed on the memory 101 in the preliminary stage, the analysis stage may be entered, for example, when the preliminary development of the sensor data of the temperature sensor A is finished, and the preliminary development of the sensor data of the temperature sensor B may be performed in the background of the analysis stage.

Although the database 102 is provided in the information processing apparatus 100A and 100B in Embodiment 1 and 2, the database 102 may be provided outside of the information processing apparatus 100A or 100B. In this case, the data can be selected from the remotely located database 102 through a network to perform the analysis.

Although the data accumulated in the database 102 is exemplified by the sensor data in Embodiment 1 and 2, a desired type of data, for example, the operation mode or operation history of the installed apparatuses, may be employed depending on the subject of the analysis.

### REFERENCE SIGNS LIST

100A: information processing apparatus, 100B: information processing apparatus, 101: memory, 102: database, 103: analysis process setup file, 103a: analysis process setup file A, 103b: analysis process setup file B, 103c: analysis process setup file C, 104: input device, 105: display device, 106: analysis process use frequency ranking file, 110: memory development instruction unit, 111: controller, 111a: visualization control unit, 112: analysis process development unit, 113: memory search unit, 114: database access unit, 200: preread memory region, 201: general memory region, 202: threshold

1. An information processing apparatus configured to visualize data extracted from a database and dialogically analyze the data, the information processing apparatus comprising:
an analysis process setup file in which one or a plurality of data items necessary for data analysis are specified;
a memory in which the data extracted from the database is developed in advance of visualization; and
a memory development instruction unit configured to extract, from the database, data of a data item of a high rank in frequency of being used for analysis, out of the one or the plurality of data items, and preliminarily develop the extracted data on the memory in advance of the analysis.

2. The information processing apparatus of claim 1, further comprising a plurality of the analysis process setup files each containing a different combination of the data items,
wherein the memory development instruction unit is configured to develop data of a data item of a high rank in frequency of appearance in the plurality of the analysis process setup files in common on the memory, as the data of the data item of a high rank in frequency of being used for analysis.

3. The information processing apparatus of claim 1, further comprising a plurality of the analysis process setup files each containing a different combination of the data items,
wherein the memory development instruction unit is configured to develop data of a data item specified in an analysis process setup file high in use frequency ranking out of the plurality of the analysis process setup files on the memory, as the data of the data item of a high rank in frequency of being used for analysis.

4. The information processing apparatus of claim 1, wherein the memory development instruction unit is configured to develop the data extracted from the database on a preread memory region for preliminary development, in the memory.

5. The information processing apparatus of claim 4, wherein the preread memory region has a memory capacity allowing the memory to stably operate.

6. The information processing apparatus of claim 4, wherein the memory development instruction unit is configured to sequentially develop data on the memory in an order of use frequency ranking of the data items from data of a data item of the highest rank in frequency of being used for analysis, within a memory capacity of the preread memory region.

7. The information processing apparatus of claim 1, further comprising a visualization control unit configured to
detect whether designated data to be analyzed is preliminarily developed on the memory when the data to be analyzed is designated through an input device,
extract the data to be analyzed from the database and develop the data on the memory when the data is not preliminarily developed, and extract the designated data to be analyzed from the memory and visualize the data, and
extract the data to be analyzed from the memory and visualize the data, when the designated data to be analyzed is preliminarily developed on the memory.

8. The information processing apparatus of claim 1, wherein the memory development instruction unit is configured to preliminarily develop the data when the information processing apparatus is activated.

9. An information processing method of visualizing data extracted from a database and dialogically analyzing the data, the information processing method comprising:
extracting, from the database, data of a data item of a high rank in frequency of being used for analysis, out of one or a plurality of data items necessary for data analysis specified in an analysis process setup file; and
preliminarily developing the extracted data on a memory in advance of the analysis.
